(19) United States
(12) Patent Application Publication
(10) Pub. No.: US 2012/0171526 A1
(43) Pub. Date: Jul. 5, 2012

(54) RUBBER VALVE FOR SEALING A BATTERY AND A LITHIUM ION BATTERY HAVING THE SAME

(76) Inventors: Yingliang JI, Shanghai (CN); Yan Zhang, Shanghai (CN); Xianping Wang, Shanghai (CN)

(21) Appl. No.: 13/340,140

(22) Filed: Dec. 29, 2011

(30) Foreign Application Priority Data
Dec. 31, 2010 (CN) 201020697938.0

(51) Int. Cl. H01M 2/12; F16K 15/14

(52) U.S. Cl. 429/54; 137/843

(57) ABSTRACT

A rubber valve for sealing a battery sealing structure is provided, comprising: a first projection in a dome shape with a center protruding upward; a second projection in a hemispherical shape with at least one diametric groove formed thereon; and a column connecting the first and the second projections. A lithium ion battery having the rubber valve is also provided.

### CROSS-REFERENCE TO RELATED APPLICATION

This application claims priority to and benefits of Chinese Patent Application No. 201020697938.0, filed with the State Intellectual Property Office, P. R. C. on Dec. 31, 2010, the content of which is incorporated herein by reference in its entirety.

### FIELD

The present disclosure relates to a rubber valve for sealing a battery and a lithium ion battery having the same.

### BACKGROUND

Lithium ion batteries are broadly used because of the advantages of small volume, high energy density, and less pollution.

After assembly, a lithium ion battery may need pre-charge to activate the active substances inside the battery, named as the formation process. The formation process may result in gas production and cause many problems in conventional batteries. For example, the gas may not be released well, and the outside moisture may leak into the battery and lead to excess water content in the electrolyte. If the gas inside the lithium ion battery cannot be released smoothly, it may cause the lithium ion battery to swell and thus seriously impair the performance and the use of the battery. Therefore, the ability of the sealing structure of the lithium ion battery to smoothly release the inside gas is an important factor affecting the battery performance.

Besides, with the development of electric vehicles and energy storage stations, the traditional sealing structure for small capacity lithium ion batteries may not satisfy the need for preparing lithium ion batteries with high capacity. For existing lithium ion batteries with high capacity, a sealing structure may reportedly include a one-way pressure relief rubber valve adapted to the cover board. Nevertheless, the existing one way pressure relief valve may cause problems during the assembly and use of the battery. It would be desirable to provide a sealing structure further improving the battery performance.

### SUMMARY

A rubber valve for sealing a battery and a lithium ion battery having the same are provided.

According to one embodiment of a first aspect of the present disclosure, a rubber valve for sealing a battery is provided, comprising: a first projection, a second projection, a column connecting the first and the second projections, wherein the first projection includes a dome shape with a center protruding upward, and the second projection includes a hemispherical shape with at least one diametric groove formed thereon.

According to one embodiment of a second aspect of the present disclosure, a lithium ion battery is provided, comprising: a shell, a cover board, an electrical core sealed in the shell; and an electrolyte sealed in the shell, wherein an electrolyte injection hole with a rubber valve mounted therein is formed on the cover board, the rubber valve comprising:

a first projection in a dome shape with a center protruding upward;

a second projection in a hemispherical shape with at least one diametric groove formed thereon; and

a column connecting the first and the second projections;

and wherein the first projection covers the outer surface of the cover board, the column extends through the electrolyte injection hole, and the second projection covers the inner surface of the cover board.

The rubber valve disclosed herein may well match with the electrolyte injection hole formed on the battery cover board and achieve the goal of one-way pressure relief. The diametric groove formed on the second projection disclosed herein may be easily prepared, and do not have the existing problems in the art. The gas inside the battery may be smoothly released and will not be affected, for example, by elastic deformation of the rubber valve or blockage with impurities. Furthermore, the diametric groove may effectively reduce the volume of the second projection to facilitate the insertion of the rubber valve into the electrolyte injection hole, so that the assembly of the battery may become easier.

Therefore, the lithium ion battery assembled with the rubber valve disclosed herein may release the gas inside the battery quickly and smoothly, and at the same time provide excellent sealing effects. The problem of battery swelling may be thus solved.

### BRIEF DESCRIPTION OF THE DRAWINGS

FIG. 1 shows the structure of a rubber valve according to one embodiment of the present disclosure;

FIG. 2 shows a cross-sectional view of a rubber valve assembled on a lithium ion battery as a sealing structure according to one embodiment of the present disclosure;

FIG. 3 shows the structure of a rubber valve according to another embodiment of the present disclosure;

FIG. 4 shows a cross-sectional view of a rubber valve assembled on a lithium ion battery as a sealing structure according to another embodiment of the present disclosure;

FIG. 5 shows the structure of a rubber valve according to yet another embodiment of the present disclosure;

FIG. 6 shows a cross-sectional view of a rubber valve assembled on a lithium ion battery as a sealing structure according to yet another embodiment of the present disclosure;

FIG. 7 shows a cross-sectional view of an electrolyte injection hole cover welded on a cover board of a lithium ion battery according to some embodiments of the present disclosure.

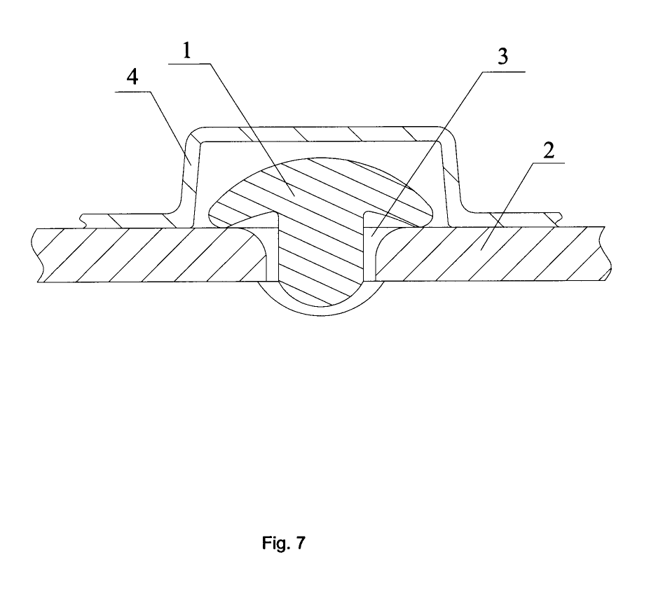

### DETAIL DESCRIPTION OF THE EMBODIMENTS

Reference will be made in detail to the embodiments of the present disclosure. The embodiments described herein are explanatory and illustrative, which are used to generally understand the present disclosure. The embodiments shall not be construed to limit the present disclosure.

According to one embodiment of a first aspect of the present disclosure, a rubber valve for sealing a battery is provided, comprising: a first projection, a second projection, a column connecting the first and the second projection, wherein the first projection includes a dome shape with a center protruding upward, and the second projection includes a hemispherical shape with at least one diametric groove formed thereon.

According to one embodiment of a second aspect of the present disclosure, a lithium ion battery is provided, comprising: a shell, a cover board 2, an electrical core sealed in the shell; and an electrolyte sealed in the shell, wherein an electrolyte injection hole 3 with a rubber valve 1 mounted therein is formed on the cover board 2, the rubber valve 1 comprising:

a first projection 11 in a dome shape with a center protruding upward;

a second projection 13 in a hemispherical shape with at least one diametric groove 14 formed thereon; and

a column 12 connecting the first and the second projections 11 and 13;

and wherein the first projection 11 covers the outer surface of the board cover 2, the column 12 extends through the electrolyte injection hole 3, and the second projection 13 covers the inner surface of the cover board 2.

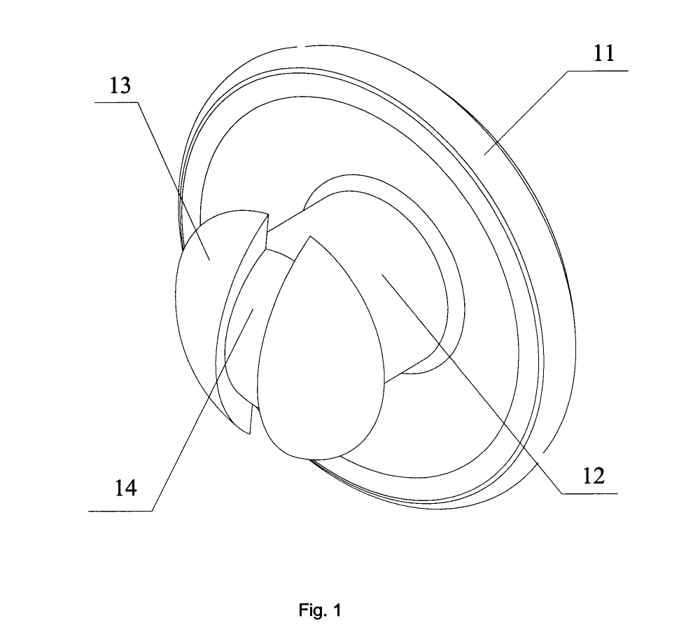

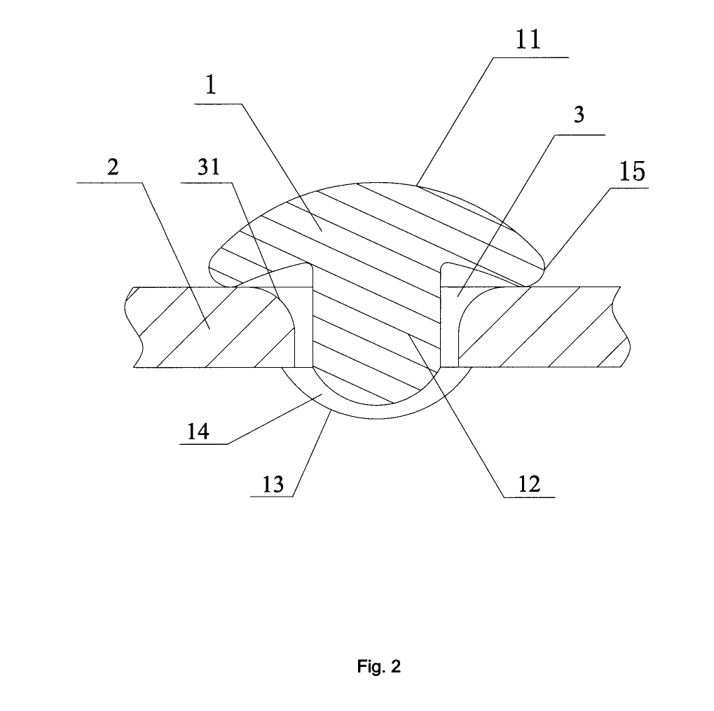

According to one embodiment of a first aspect of the present disclosure, a rubber valve 1 for sealing a battery is provided. As shown in FIG. 1 and FIG. 2, a rubber valve 1 according to one embodiment of the present disclosure may comprise: a first projection 11 in a dome shape with a center protruding upward; a second projection 13 in a hemispherical shape; and a column 12 connecting the first and the second projection 11 and 13; wherein at least one diametric groove 14 is formed on the second projection 13. The at least one diametric groove 14 formed on the second projection 13 may prevent the deformation of the rubber valve 1 caused by outside environmental changes; therefore the gas produced inside the battery during the formation process may be released smoothly. Moreover, when the rubber valve 1 is being inserted into an electrolyte injection hole 13, the diametric groove 14 may reduce the volume of the second projection 13 to facilitate the assembly thereof.

According to one embodiment of the present disclosure, as shown in FIG. 2, an edge 15 of the first projection 11 in contact with the cover board 2 may include a shape of a transitional circular arc. The edge 15 designed according to the present disclosure may increase the contact area between the first projection 11 and the battery cover board 2, so that the first projection 11 may tightly match with the cover board 2, enhancing the battery sealing effect.

According to one embodiment of the present disclosure, as shown in FIG. 1, one diametric groove 14 may be formed diametrically across the surface of the second projection 13.

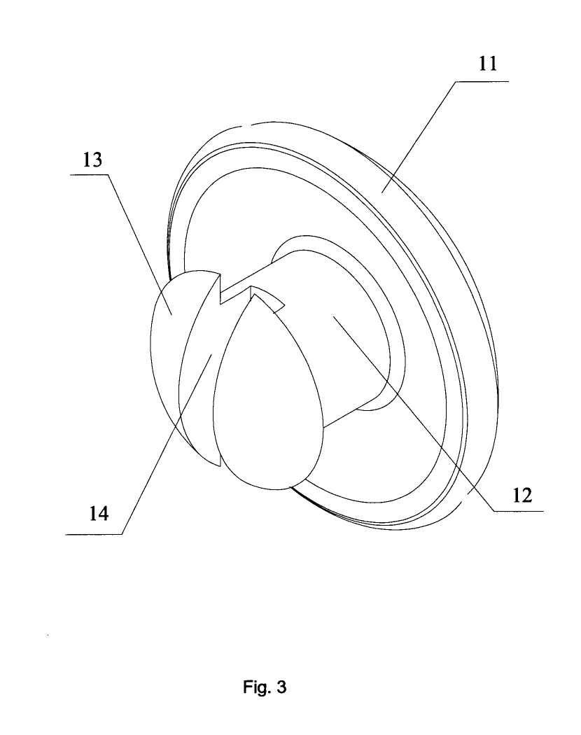

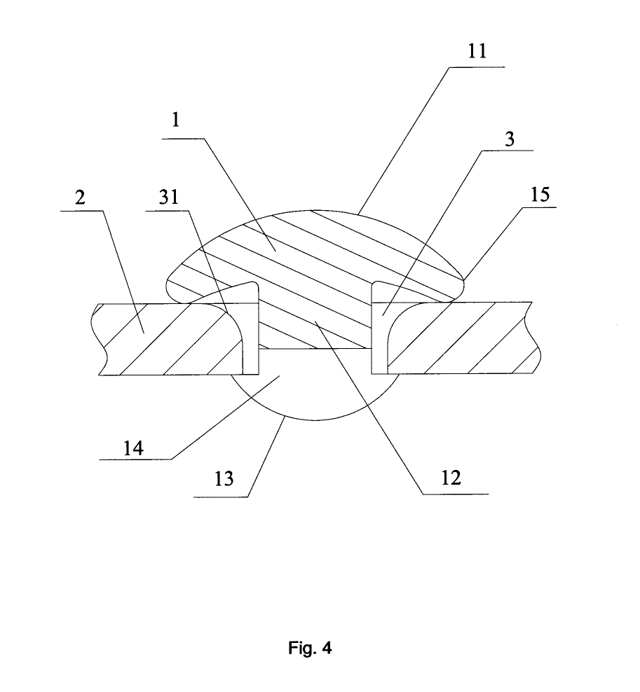

According to another embodiment of the present disclosure, as shown in FIGS. 3 and 4, the depth of the diametric groove 14 may extend to the body of the column 12 to increase the gas releasing amount. Therefore, the gas inside the battery may be released easily during the formation process.

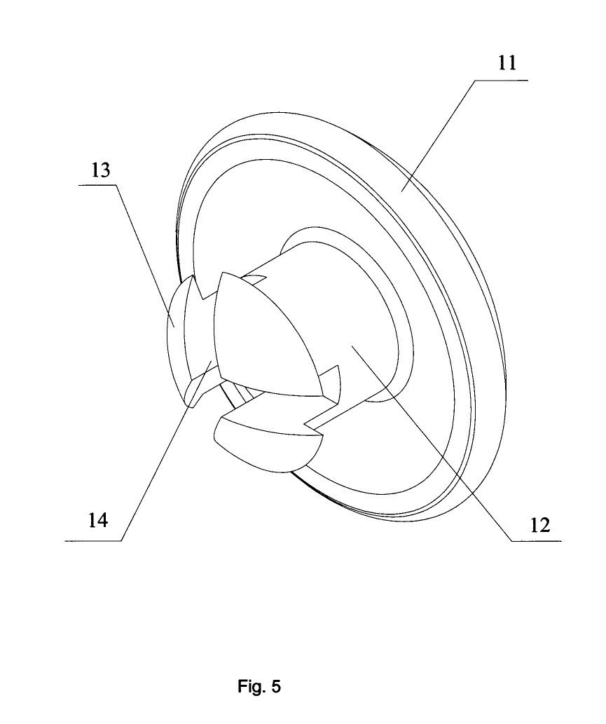

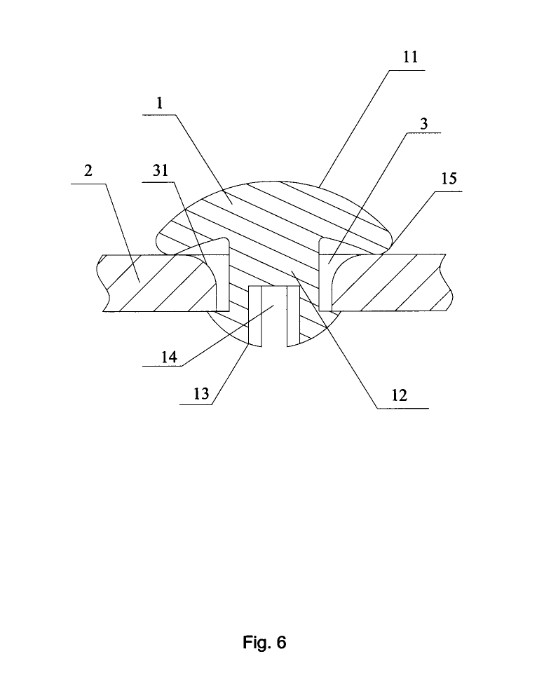

According to yet another embodiment of the present disclosure, as shown in FIGS. 5 and 6, the at least one diametric groove 14 may include three grooves rotationally spaced in a Y shape to equally divide the surface of the second projection 13 into three parts. In this way, the gas releasing amount may be further increased; the volume of the second projection 13 may be further reduced while it is being inserted into the electrolyte injection hole 13.

The rubber valve 1 disclosed herein may decrease the assembling difficulty while enhance the gas releasing function and sealing performance. Therefore, a lithium ion battery may be easily assembled with the rubber valve 1. Even when the rubber valve 1 has a certain degree of elastic deformation, the at least one diametric groove 14 may also effectively release the gas inside the battery, thus enhancing the one-way pressure relief ability.

The rubber valve 1 disclosed herein may be recycled and reused, which means that the rubber valve 1 may also be used as a temporary sealing structure. After one lithium ion battery is finished with the formation process, the rubber valve 1 may be reused on another lithium ion battery. Meanwhile, the rubber valve 1 provided herein may also be used as a permanent sealing member of the lithium ion battery, which means that the rubber valve 1 may be an integral part of the lithium ion battery.

According to one embodiment of a second aspect of the present disclosure, a lithium ion battery is provided, comprising: a shell; a cover board 2; an electrical core sealed in the shell; and an electrolyte sealed in the shell; wherein an electrolyte injection hole 3 with a rubber valve 1 mounted therein is formed on the cover board 2, the rubber valve 1 comprising:

a first projection 11 in a dome shape with a center protruding upward;

a second projection 13 in a hemispherical shape with at least one diametric groove 14 formed thereon; and

a column 12 connecting the first and the second projections 11 and 13;

and wherein the first projection 11 covers the outer surface of the board cover 2, the column 12 extends through the electrolyte injection hole 3, and the second projection 13 covers the inner surface of the cover board 2.

The electrolyte may be injected through the electrolyte injection hole 3 on the cover board 2. After injection, the lithium ion battery may be subjected to the formation process. The rubber valve 1 disclosed herein may be inserted into the electrolyte injection hole 3 to insulate the battery from outside moisture and impurities and to release the gas produced inside the battery during the formation process. The first projection 11 and the second projection 13 may respectively cling to the inner surface and the outer surface of the cover board 2. The gas produced during formation may be released to the outside through the at least one diametric groove 14 formed on the second projection 13. In some embodiments, an electrolyte injection hole cover 4 may be also welded on the battery cover board 2 to seal the rubber valve 1.

According to one embodiment of the present disclosure, as shown in FIG. 2, an edge 15 of the first projection 11 in contact with the cover board 2 may include a shape of a transitional circular arc. The edge 15 designed according to the present disclosure may increase the contact area between the first projection 11 and the battery cover board 3, so that the first projection 11 may tightly match with the cover board 2, enhancing the battery sealing effect.

According to one embodiment of the present disclosure, as shown in FIG. 1, one diametric groove 14 may be formed diametrically across the surface of the second projection 13.

According to another embodiment of the present disclosure, as shown in FIGS. 3 and 4, the depth of the diametric groove 14 may extend to the body of the column 12 to release the gas releasing amount. Therefore, the gas inside the battery may be released easily during the formation process.

According to yet another embodiment of the present disclosure, as shown in FIGS. 5 and 6, the at least one diametric groove 14 may include three grooves rotationally spaced in a Y shape to equally divide the surface of the second projection 13 into three parts. In this way, the gas releasing amount may be further increased, and the volume of the second projection 13 may be further decreased when it is being inserted into the electrolyte injection hole 3.

According to some embodiments of the present disclosure, as shown in FIGS. 2, 4 and 6, an upper edge 31 of the electrolyte injection hole 3, which is located at the outer surface of the cover board 2, may include a shape of a transitional circular arc. In this way, the second projection 13 of the rubber valve 1 may be easily inserted into the electrolyte injection hole 3, therefore simplifying the assembly process.

According to some embodiments of the present disclosure, as shown in FIGS. 2, 4 and 6, the diameter of the column 12 may be smaller than the diameter of the electrolyte injection hole 3. The clearance between the column 12 and the electrolyte injection hole 3 may form a gas passageway to release the gas produced inside the battery.

According to some embodiments of the present disclosure, the electrolyte injection hole cover 4 may include a round metal cover of which the center has a column ridge.

According to some embodiments of the present disclosure, as shown in FIGS. 1 to 6, the thickness of the thickest portion of the first projection 11 may be greater than the width of the clearance between the column 12 and the electrolyte injection hole 3. Thus even when the stress is greater than a predetermined value, the first projection 11 of the rubber valve 1 may still not be able to slip into the electrolyte injection hole 3. Comparatively, the thickness of the first projection of existing rubber valves may be too thin to prevent the first projection from slipping into the electrolyte injection hole, making it difficult to insert the second projection into the electrolyte injection hole.

Therefore, the lithium ion battery assembled with the rubber valve disclosed herein may release the gas inside the battery quickly and smoothly, and at the same time provide excellent sealing effects. The problem of battery swelling may be thus solved.

Although explanatory embodiments have been shown and described, it would be appreciated by those skilled in the art that changes, alternatives, and modifications can be made in the embodiments without departing from spirit and principles of the invention. Such changes, alternatives, and modifications all fall into the scope of the claims and their equivalents.

What is claimed is:

1. A rubber valve for sealing a battery, comprising:
a first projection in a dome shape protruding upward;
a second projection in a hemispherical shape; and
a column connecting the first and the second projections;
wherein at least one diametric groove is formed on the second projection.

2. The rubber valve according to claim 1, wherein an edge of the first projection comprises a shape of a transitional circular arc.

3. The rubber valve according to claim 1, wherein one diametric groove is formed diametrically across the surface of the second projection.

4. The rubber valve according to claim 1, wherein the depth of the at least one diametric groove formed on the second projection extends to the body of the column.

5. The rubber valve according to claim 1, wherein the at least one diametric groove comprises three grooves rotationally spaced in a substantially Y shape.

6. A lithium ion battery, comprising:
a shell;
a cover board;
an electrical core sealed in the shell; and
an electrolyte sealed in the shell;
wherein an electrolyte injection hole with a rubber valve mounted therein is formed on the cover board, the rubber valve comprising:
a first projection in a dome shape protruding upward;
a second projection in a hemispherical shape with at least one diametric groove formed thereon; and
a column connecting the first and the second projections;
and wherein the first projection covers the outer surface of the board cover, the column extends through the electrolyte injection hole, and the second projection covers the inner surface of the cover board.

7. The lithium ion battery according to claim 6, wherein an edge of the first projection comprises a shape of a transitional circular arc.

8. The lithium ion battery according to claim 6, wherein one diametric groove is formed diametrically across the surface of the second projection.

9. The lithium ion battery according to claim 6, wherein the depth of the at least one diametric groove formed on the second projection extends to the body of the column.

10. The lithium ion battery according to claim 6, wherein the at least one diametic groove comprises three grooves rotationally spaced in a substantially Y shape.

11. The lithium ion battery according to claim 6, wherein an electrolyte injection hole cover is welded on the cover board to seal the rubber valve.

12. The lithium ion battery according to claim 6, wherein an upper edge of the electrolyte injection hole comprises a shape of a transitional circular arc.

13. The lithium ion battery according to claim 6, wherein the diameter of the column is smaller than the diameter of the electrolyte injection hole.

14. The lithium ion battery according to claim 6, wherein the thickness of the thickest portion of the first projection is greater than the width of the clearance between the column and the electrolyte injection hole.

15. The lithium ion battery according to claim 6, wherein the rubber valve is a permanent or a temporary sealing structure for the lithium ion battery.
